(19) United States
(12) Patent Application Publication
(10) Pub. No.: US 2026/0081327 A1
(43) Pub. Date: Mar. 19, 2026

(54) REMOVABLE AND REPLACEABLE PORT ASSEMBLY FOR A BATTERY PACK

(71) Applicant: Ford Global Technologies, LLC, Dearborn, MI (US)

(72) Inventors: Steve Droste, Canton, MI (US); Rajaram Subramanian, Ann Arbor, MI (US); Kevin Montgomery, Royal Oak, MI (US); Hari Krishna Addanki, Novi, MI (US)

(21) Appl. No.: 18/889,218

(22) Filed: Sep. 18, 2024

(51) Int. Cl. H01M 50/627; H01M 10/613; H01M 50/691

(52) U.S. Cl. CPC H01M 50/627; H01M 10/613; H01M 50/691

(57) ABSTRACT

Systems are provided that enable external regress and service of a port assembly of a battery pack assembly. In one example, a system includes a first port casing member that is coupleable with a second port casing member that is tiered via a pair of fasteners that extend from the second port casing member to the first port casing member to compress a seal spaced between the first port casing member and the second port casing member, a port outlet positioned on a surface of the first port casing member, and a port inlet positioned on a surface of the second port casing member.

### FIELD

The present description relates generally to a port assembly for a battery pack that is removable and replaceable.

### Background/Summary

Electric vehicles (EVs) include battery packs that demand thermal control and electrical connection to other components of the respective EV. Integral port assemblies may provide thermal control and enable electrical connection of the battery packs. Vehicles having battery packs with integral port assemblies and connections may be designed to provide convenient regress and/or service to the assemblies.

In one example, the issues described above may be addressed by a port assembly, comprising a first port casing member that is coupleable with a second port casing member that is tiered via a pair of fasteners that extend from the second port casing member to the first port casing member to compress a seal spaced between the first port casing member and the second port casing member, a port outlet positioned on a surface of the first port casing member, and a port inlet positioned on a surface of the second port casing member. By arranging the port assembly in such a manner, the port outlet is removable and replaceable from outside a battery pack. As such, regress and/or service of the battery pack may be performed from outside of the battery pack. In turn, this may reduce serving, reduce time for inspection of the battery pack, and increase the quality of the battery pack.

As one example, two port assemblies may be arranged in a battery pack assembly. More specifically, the battery pack assembly may include a plurality of cells arranged within a battery housing of the battery pack assembly. The battery housing is configured for a port housing that encloses a pair of port assemblies. Each port assembly includes a port outlet coupled to a first port casing member that comprises a first base portion, a first elevated portion configured for a first fastener that is disposed on one side of the port outlet, and a second elevated portion configured for a second fastener that is disposed on another side of the port outlet, and a port inlet coupled to second port casing member that comprises a first tier, a second tier, and is spaced apart from the first port casing member via a seal. The port inlet of each port assembly extends through the port housing on an interior side of the battery pack assembly and the port outlet extends through the port housing on an exterior side of the battery pack.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows a first perspective view of an exterior of a port assembly.

FIG. 2 schematically shows a second perspective view of an exterior of the port assembly.

FIG. 3 schematically shows a third perspective view of an exterior of the port assembly.

FIG. 4 schematically shows a perspective view of an interior of a second port casing member.

FIG. 5 schematically shows a perspective view an interior of a first port casing member.

FIG. 6 schematically shows a cross section of the port assembly.

FIG. 7 schematically shows a battery pack assembly with two molded port assemblies integrated therein.

FIG. 8 schematically shows a cross section of the two molded port assemblies when integrated in a housing.

### DETAILED DESCRIPTION

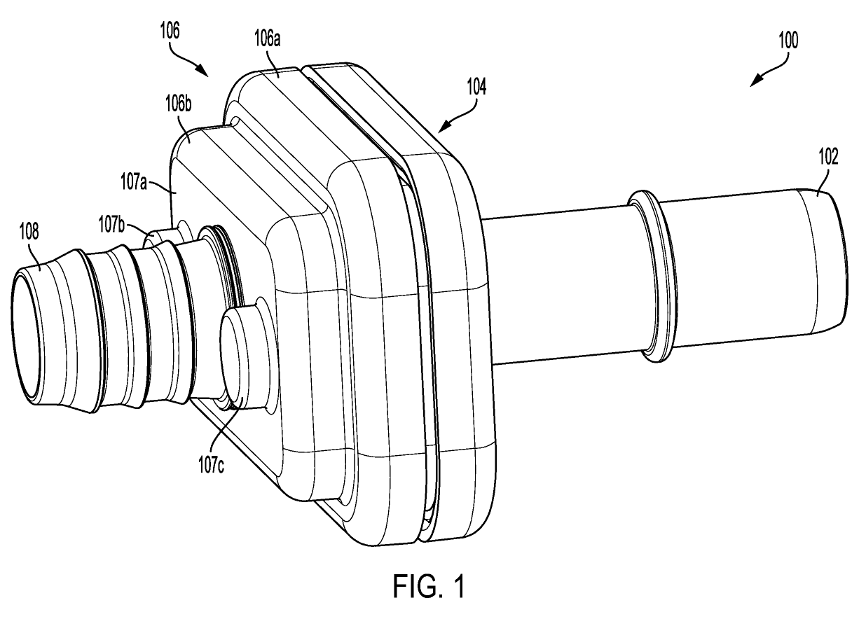

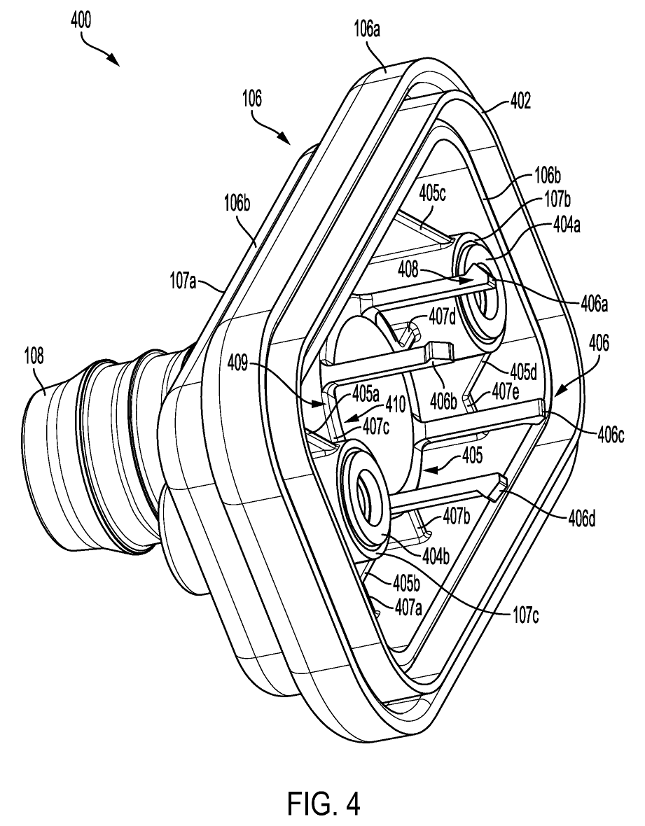

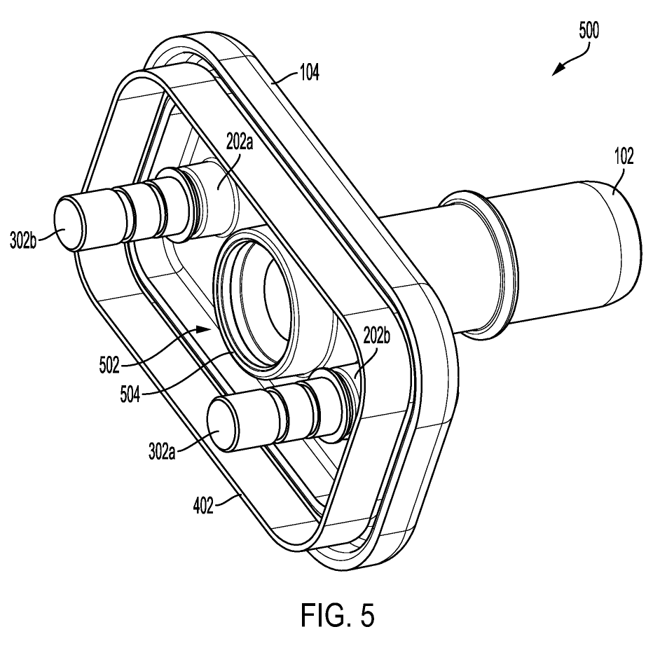

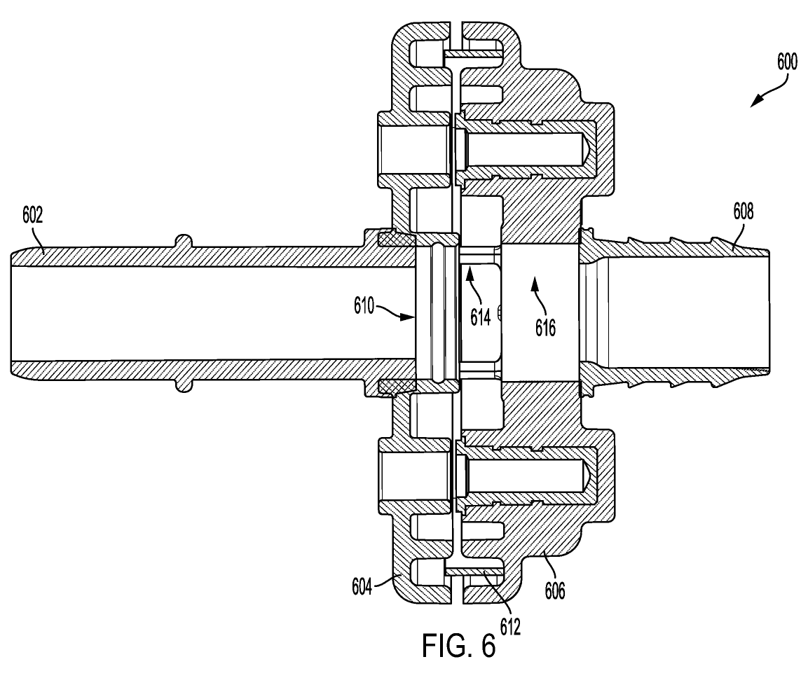

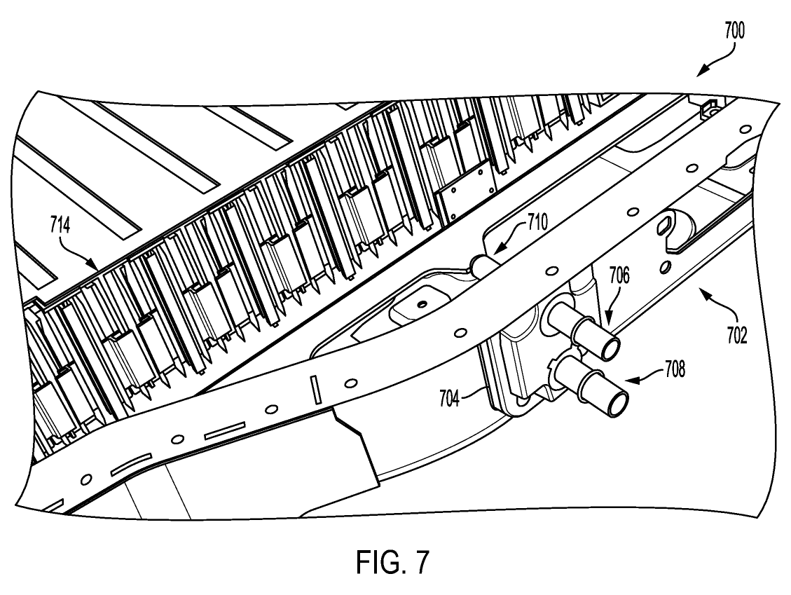

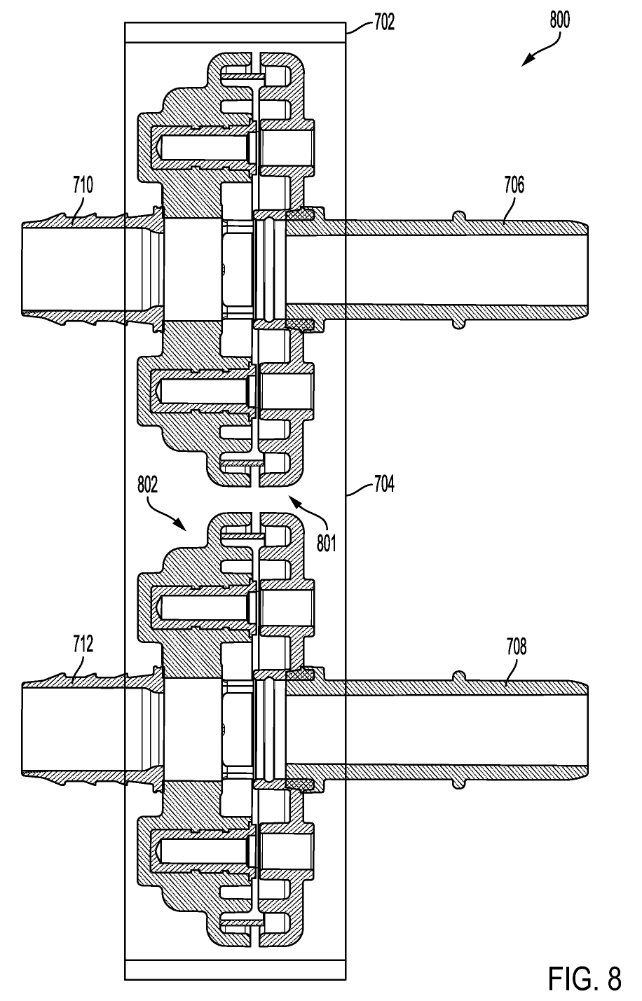

The following description relates to systems for providing coolant to a battery pack assembly. The battery pack assembly integrates a port assembly that enables regress and service of the port assembly from outside of the battery pack. More specifically, the battery pack assembly includes two port assemblies wherein one port assembly operates as an inlet port and the other port assembly operates as an outlet port. The same port assembly is used for both of the inlet port and the outlet port. FIGS. 1-3 depict different perspective view of an exterior of the port assembly. FIG. 4 depicts an interior perspective view of a second port casing member and FIG. 5 depicts an interior perspective view of a first port casing member of the port assembly. A cross section of the port assembly is depicted in FIG. 6. A battery pack assembly integrated with the port assembly is depicted in FIG. 7. A cross section of a port housing of the battery pack assembly is depicted in FIG. 8.

Turning now to the figures, FIG. 1 illustrates a first perspective view of an exterior of a port assembly 100 wherein coolant or other fluids may flow. In particular, the first perspective view focuses on an inlet-side of the port assembly 100. The port assembly 100 includes a port outlet 102, a first port casing member 104, a second port casing member 106 that is tiered, and a port inlet 108. The port outlet 102 is positioned on a surface of the first port casing member 104 and the port inlet 108 is positioned on a surface of the second port casing member 106. The first port casing member 104 is coupleable with the second port casing member 106 via a pair of fasteners (e.g., not shown) that compress a seal spaced between the first port casing member and the second port casing member.

The second port casing member includes a first tier 106a and a second tier 106b. The second tier includes a second base portion 107a with a cross section that is rounded rectangular in shape and two elevated portions with a cross section that is circular in shape. The two elevated portions are positioned on a top surface of the second base portion of the second port casing member 106. The two elevated portions of the second tier are spaced apart on either side of the center of the second base portion 107a of the second port casing member 106 and offset from the center of the second base portion by a pre-determined distance. One elevated portion of the second tier is positioned on one side of the port inlet 108 and another elevated portion is positioned on another side of the port inlet.

More specifically, the two elevated portions include a third elevated portion 107b and fourth elevated portion 107c. It follows that the third elevated portion 107b is positioned on one side of the port inlet 108 and the fourth elevated portion is positioned on another side of the port inlet. A cross section of the first tier 106a is a rounded rectangular shape and the cross section of the first tier is larger in size compared to the cross section of the second base portion 107a of the second tier 106b. A center of the first tier 106a is aligned with a center of the second base portion 107a of the second tier 106b. The seal surrounds an inner perimeter of the first port casing member 104 and an inner perimeter of the first tier of the second port casing member 106.

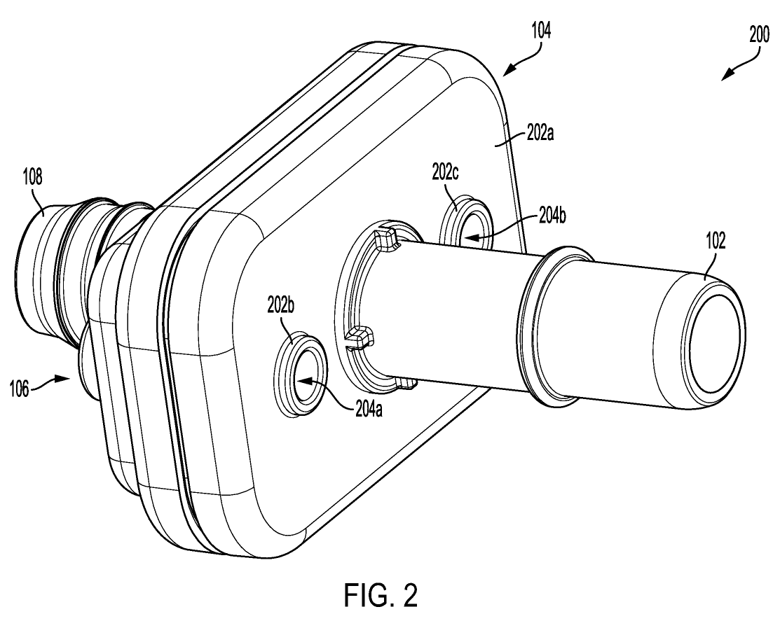

FIG. 2 illustrates a second perspective view 200 of the port assembly 100 depicted in FIG. 1. Elements included in port assembly 100 of FIG. 1 may not be reintroduced, for brevity. The second perspective view of the exterior of the first port assembly focuses on the outlet-side of the port assembly 100. The first port casing member 104 comprises a first base portion 202a with a cross section that is rounded rectangular in shape and two elevated portions positioned on a top surface of the first base portion of the first port casing member, the two elevated portions being configured with through holes that position the pair of fasteners. The two elevated portions are spaced apart spaced apart on either side of the center of the first base portion 202a of the first port casing member 104 and offset from the center of the first base portion by a pre-determined distance such that one elevated portion of the first port casing member is positioned on one side of the port outlet 102 and another elevated portion is positioned on another side of the port outlet.

In particular, the two elevated portions include a first elevated portion 202b and a second elevated portion 202c. Accordingly, the first elevated portion 202b of the first port casing member 104 is positioned on one side of the port outlet 102 and the second elevated portion 202c is positioned on another side of the port outlet. The first elevated portion 202b of the first port casing member 104 is configured with a first through hole 204a on one side of the port outlet 102 and the second elevated portion 202c of the first port casing member is configured with a second through hole 204b on another side of the port outlet. The first through hole 204a and the second through hole 204b extend through the first elevated portion 202b, the second elevated portion 202c, and the first base portion 202a of the first port casing member 104.

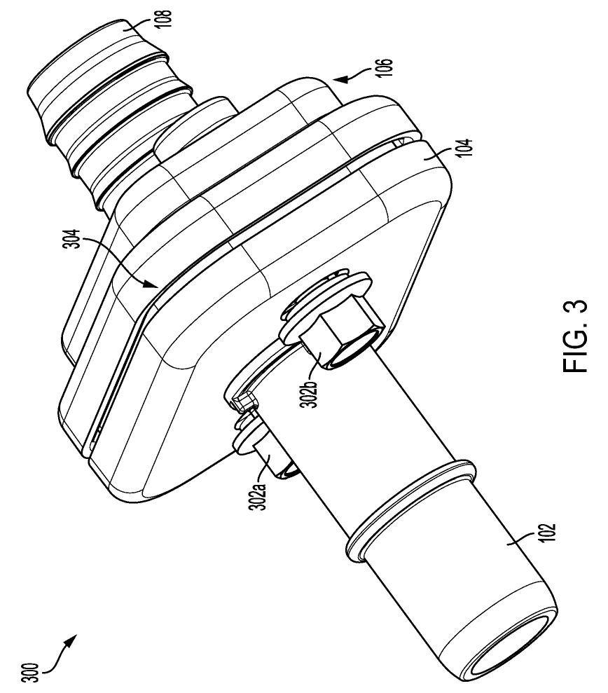

Turning to FIG. 3, a third perspective view 300 of the port assembly 100 is depicted. Elements included in port assembly 100 of FIGS. 1 and 2 may not be reintroduced, for brevity. The third perspective view 300 includes a pair of through holes that position a pair of fasteners that extend through the first port casing member 104. In particular, the first through hole 204a positions a first fastener 302a and the second through hole 204b positions a second fastener 302b. The first fastener 302a and the second fastener 302b compress a seal 304 to prevent fluid, such as a coolant, from leaking from the port assembly. One side of the seal 304 is positioned on an inner perimeter of the first port casing member 104 and another side of the seal is positioned on an inner perimeter of the second port casing member 106.

FIG. 4 depicts a perspective view 400 of an interior of the second port casing member 106 of the port assembly 100 of FIG. 1. Elements included in FIG. 1-3 may not be reintroduced, for brevity. The second base portion 107a, the third elevated portion 107b, and the fourth elevated portion 107c of the second tier 106b extend into an interior side of the second port casing member 106 where triangular supports disposed on both of the third elevated portion 107b and the fourth elevated portion 107c connect the second base portion 107a with the third elevated portion and the fourth elevated portion. As an example, the triangular supports may include a first triangular support 405a, a second triangular support 405b, a third triangular support 405c, and a fourth triangular support 405d.

The first triangular support 405a and the second triangular support 405b may be disposed on the third elevated portion 107b to connect the second base portion 107a and the third elevated portion 107b. Similarly, the third triangular support 405c and the fourth triangular support 405d may be disposed on the fourth elevated portion 107c to connect the second base portion 107a and the fourth elevated portion 107c. Additionally, the second tier 106b includes a second circular opening that extends from an exterior side of the second port casing member 106 to the interior side of the second molded port casing member, forming a second tubular portion 405 wherein fluid is transported to an exterior of the port assembly 100 from the interior of the port assembly. In some embodiments, the exterior of the port assembly 100 is an interior of a battery pack assembly, such as the battery pack assembly depicted below in FIG. 7.

The port assembly 100 includes rectangular supports that connect the second tubular portion 405 and the third elevated portion 107b, the second tubular portion and the fourth elevated portion 107c, the second base portion 107a of the second tier 106b and the third elevated portion, and the second base portion of the second tier and the fourth elevated portion. More specifically, rectangular supports are disposed around the perimeter of the second tubular portion 405 to connect the second tubular portion to the second tier 106b. Further, additional rectangular supports are disposed on an outer perimeter of the third elevated portion 107b and the fourth elevated portion 107c.

In an example, the rectangular supports may include a first rectangular support 407a, a second rectangular support 407b, a third rectangular support 407c, a fourth rectangular support 407d, and a fifth rectangular support 407e. In particular, the first rectangular support 407a may connect the third elevated portion 107b and the second base portion 107a of the second tier 106b, the second rectangular support 407b may connect the second tubular portion 405 and the second base portion of the second tier, and the fifth rectangular support 407e may connect the fourth elevated portion 107c and the base of the second tier. Further, the third rectangular support 407c may connect the second tubular portion 405 and the third elevated portion 107b. Additionally, the fourth rectangular support 407d may connect the second tubular portion and the fourth elevated portion 107c. The triangular support and the rectangular supports provide structural support for the different elements of the second port casing member 106. Other embodiments of the port assembly 100 may include more or fewer triangular supports and/or rectangular supports without departing from the scope of the present disclosure.

A plurality of projecting members 406 extends from an outer perimeter of an end of the second tubular portion 405. The plurality of projecting members may include a first projecting member 406a, a second projecting member 406b, a third projecting member 406c, and a fourth projecting member 406d. A shape of each projecting member is a rectangular prism with a portion 408 of one side of one end of the respective projecting member having a rounded wedge shape. The side of the projecting member with the rounded wedge shape is faced toward the outer perimeter 409 of the second tubular portion 405 and the rectangular side parallel to the side with the rounded wedge shape is faced toward the inner perimeter 410 of the second tubular portion.

A first positioning member 404a and a second positioning member 404b are cylindrical in shape and configured to be positioned inside the first elevated portion 202b and the second elevated portion 202c of the second port casing member 106 and receive the first fastener 302a and the second fastener 302b, respectively. Additionally, one end of the seal 402 is positioned around a perimeter of the interior of the second base portion 107a of the second port casing member 106. More specifically, the one end of the seal 402 is positioned between the first tier 106a and the outer perimeter of the second base portion 107a of the second tier 106b.

FIG. 5 illustrates a perspective view 500 of an interior of the first port casing member 104 of the port assembly 100 of FIG. 1. Elements included in FIGS. 1-4 may not be reintroduced, for brevity. The first port casing member 104 includes an inner wall 502 that forms a cross section that is rounded rectangular in shape, the cross section of the inner wall being smaller than a cross section of the first base portion 202a of the first port casing member. Another end of the seal 402 is positioned around a perimeter of the interior of the first base portion 202a of the first port casing member 104. In particular, the other end of the seal 402 is positioned between the inner wall 502 and the first base portion 202a of the first port casing member 104. The first port casing member 104 further includes a first circular opening that extends from an exterior side of the first port casing member to the interior side of the first molded port casing member, forming a first tubular portion 504 wherein fluid is transported to an exterior of the port assembly.

For example, the exterior of the port assembly may be an exterior of a battery pack assembly, such as the battery pack assembly depicted below in FIG. 7. Additionally, each of the first elevated portion 202b and the second elevated portion 202c may extend from the exterior side of the first port casing member 104 to the interior side of the first molded port casing member to form a cylindrical structure that positions one end of the fastener. The first fastener 302a extends from the first through hole 204a through an interior of the first port casing member 104 to the first positioning member 404a located in the interior of the second port casing member 106. The second fastener 302b extends from the second through hole 204b through the interior of the first port casing member 104 to a second positioning member 404b located in the interior of the second port casing member 106.

FIG. 6 depicts a cross section view 600 of a molded port assembly, which may be an embodiment of the port assembly 100 depicted in FIG. 1. The molded port assembly may include a port outlet 602 coupled to a first molded port casing member 604. The first molded port casing member 604 is arranged with a first base portion, a first elevated portion configured with a first through hole that is positioned on one side of the port outlet 602, and a second elevated portion configured with a second through hole that is positioned on another side of the port outlet. The molded port assembly may also include a port inlet 608 that is coaxial with the port outlet 602 and coupled to a second molded port casing member 606. The second molded port casing member 606 may comprise a first tier and a second tier wherein the second tier comprises a second base portion, a third elevated portion positioned on one side of the port inlet 608, and a fourth elevated portion positioned on another side of the port inlet.

The first through hole positions a first fastener and the second through hole positions a second fastener that compress a seal 612. One side of the seal 612 is positioned on an inner perimeter of the first molded port casing member 604 and another side of the seal is positioned on an inner perimeter of the second molded port casing member 606. A plurality of projecting members 614 disposed on a second tubular portion 610 of the second molded port casing member 606 are in contact with a first tubular portion 616 of the first molded port casing member 604.

FIG. 7 illustrates a battery pack assembly 700 wherein the molded port assembly described herein is integrated therein. The battery pack assembly 700 includes a plurality of cells 714 arranged within a battery housing 702 of the battery pack assembly. The battery housing 702 is configured for a port housing 704 that encloses a pair of port assemblies. Each port assembly comprises a port outlet coupled to a first port casing member. The first port casing member comprises a first base portion, a first elevated portion configured for a first fastener on one side of the port outlet, and a second elevated portion configured for a second fastener on another side of the port outlet.

Each port assembly further comprises a port inlet coupled to second port casing member. The second port casing member comprises a first tier and a second tier and is spaced apart from the first port casing member via a seal. The port inlet of each port assembly extends through the port housing 704 on an interior side of the battery pack assembly 700 and the port outlet extends through the port housing 704 on an exterior side of the battery pack assembly. For example, a first port inlet 710 and a second port inlet (not shown) extends through the port housing 704 on the interior side of the battery pack assembly 700, and a first port outlet 706 and a second port outlet 708 extends through the port housing 704 on the exterior side of the battery pack assembly.

By configuring the battery pack assembly 700 with the molded port assembly disclosed herein, the inlet ports may be serviced regardless of degradation to the outlet ports. Accordingly, the port assembly may be repaired without opening the battery pack assembly or replacing the battery pack assembly altogether. As such, the port assembly disclosed herein enables less demanding regress and service of the battery pack assembly, which may allow for more thorough inspections of the battery pack assembly and higher quality battery back assemblies.

A cross section view 800 of the battery housing 702 of the battery pack assembly 700 depicted in FIG. 7 is illustrated in FIG. 8. Elements included in FIG. 7 may not be reintroduced, for brevity. A first port assembly 801 and a second port assembly 802 is enclosed in the port housing 704. The first port assembly 801 is positioned above the second port assembly 802 within the port housing 704. In this way, a first port inlet 710 of the first port assembly 801 is positioned above a second port inlet 712 of the second port assembly 802 and a first port outlet 706 of the first port assembly 801 is positioned above a second port outlet 708 of the second port assembly 802.

Coolant may enter through one of the first port assembly 801 and the second port assembly 802 to remove heat generated during operation of the battery pack assembly 700. Conversely, coolant that has absorbed the generated heat may be removed from the battery pack assembly 700 through one of the first port assembly and the second port assembly. In other words, coolant may enter the battery pack assembly 700 via the first port assembly 801 and be removed from the battery pack assembly via the second port assembly 802. In this embodiment, the first port assembly 801 functions as an inlet port and the second port assembly 802 operates as an outlet port. It follows that the coolant enters the battery pack assembly 700 when the coolant flows into the first port outlet 706 and out of the first port inlet 710 of the first port assembly 801. The coolant is removed from the battery pack assembly 700 when the heated coolant flows into the second port inlet 712 and out of the second port outlet 708 of the second port assembly 802.

Conversely, coolant may enter the battery pack assembly 700 via the second port assembly 802 and be removed from the battery pack assembly via the first port assembly 801. In this embodiment, the second port assembly 802 functions as an inlet port and the first port assembly 801 operates as an outlet port. It follows that the coolant enters the battery pack assembly 700 when the coolant flows into the second port outlet 708 and out of the second port inlet 712 of the second port assembly 802. The coolant is removed from the battery pack assembly 700 when the heated coolant flows into the first port inlet 710 and out of the first port outlet 706 of the first port assembly 801.

The technical effect of integrating a port assembly comprising a first port casing member that is tiered and coupled to a second port casing member to compress a seal positioned between the first port casing member and the second port casing member into a battery pack assembly is that regress and service of the port assembly may be performed outside of the battery pack assembly. In this way, the port assembly may be repaired or replaced without opening the battery pack assembly or replacing the battery pack assembly, which may reduce downtime of the battery pack assembly, increase the efficiency of inspections, and thus, increase the quality of the battery pack assembly.

The disclosure also provides support for a port assembly, comprising: a first port casing member that is coupleable with a second port casing member that is tiered via a pair of fasteners that extend from the second port casing member to the first port casing member to compress a seal spaced between the first port casing member and the second port casing member, a port outlet positioned on a surface of the first port casing member, and a port inlet positioned on a surface of the second port casing member. In a first example of the system, the port outlet is removable and replaceable from outside a battery pack. In a second example of the system, optionally including the first example, the first port casing member comprises a first base portion with a cross section that is rounded rectangular in shape and two elevated portions positioned on a top surface of the first base portion of the first port casing member, the two elevated portions being configured with through holes that position the pair of fasteners.

In a third example of the system, optionally including one or both of the first and second examples, the two elevated portions are spaced apart spaced apart on either side of a center of the first base portion of the first port casing member and offset from the center of the first base portion by a pre-determined distance such that one elevated portion of the first port casing member is positioned on one side of the port outlet and another elevated portion is positioned on another side of the port outlet. In a fourth example of the system, optionally including one or more or each of the first through third examples, the second port casing member includes a first tier and a second tier, the second tier comprising a second base portion with a cross section that is rounded rectangular in shape and two elevated portions with a cross section that is circular in shape and positioned on a top surface of the second base portion of the second port casing member.

In a fifth example of the system, optionally including one or more or each of the first through fourth examples, the two elevated portions of the second tier are spaced apart on either side of a center of the second base portion of the second port casing member and offset from the center of the second base portion by a pre-determined distance such that one elevated portion of the second tier is positioned on one side of the port inlet and another elevated portion is positioned on another side of the port inlet. In a sixth example of the system, optionally including one or more or each of the first through fifth examples, a cross section of the first tier is a rounded rectangular shape, the cross section of the first tier is larger in size compared to the cross section of the second base portion of the second tier, and a center of the first tier is aligned with the center of the second base portion of the second tier. In a seventh example of the system, optionally including one or more or each of the first through sixth examples, the seal surrounds an inner perimeter of the first port casing member and an inner perimeter of the first tier of the second port casing member.

The disclosure also provides support for a molded port assembly, comprising: a port outlet coupled to a first molded port casing member, the first molded port casing member being arranged with a first base portion, a first elevated portion configured with a first through hole that is positioned on one side of the port outlet and a second elevated portion configured with a second through hole that is positioned on another side of the port outlet, a port inlet that is coaxial with the port outlet and coupled to a second molded port casing member, the second molded port casing member comprising a first tier and a second tier, the second tier comprising a second base portion, a third elevated portion positioned on one side of the port inlet, and a fourth elevated portion positioned on another side of the port inlet, wherein the first through hole positions a first fastener and the second through hole positions a second fastener that compress a seal wherein one side of the seal is positioned on an inner perimeter of the first molded port casing member and another side of the seal is positioned on an inner perimeter of the second molded port casing member.

In a first example of the system, the second base portion, the third elevated portion, and the fourth elevated portion of the second tier extend into an interior side of the second molded port casing member where triangular supports disposed on both of the third elevated portion and the fourth elevated portion connect the second base portion with the third elevated portion and the fourth elevated portion. In a second example of the system, optionally including the first example, the second tier includes a second circular opening that extends from an exterior side of the second molded port casing member to the interior side of the second molded port casing member, forming a second tubular portion wherein fluid is transported to an interior of the molded port assembly. In a third example of the system, optionally including one or both of the first and second examples, rectangular supports are disposed around a perimeter of the second tubular portion to connect the second tubular portion to the second tier and a plurality of projecting members extends from an outer perimeter of an end of the second tubular portion.

In a fourth example of the system, optionally including one or more or each of the first through third examples, a shape of each projecting member is a rectangular prism with a portion of one side of one end of the respective projecting member having a rounded wedge shape. In a fifth example of the system, optionally including one or more or each of the first through fourth examples, the first fastener and the second fastener are not coaxial and a first positioning member and a second positioning member are cylindrical in shape and configured to be positioned inside the third elevated portion and the fourth elevated portion of the second molded port casing member and receive the first fastener and the second fastener, respectively. In a sixth example of the system, optionally including one or more or each of the first through fifth examples, the first molded port casing member includes an inner wall that forms a cross section that is rounded rectangular in shape, the cross section of the inner wall being smaller than a cross section of the first base portion of the first molded port casing member.

In a seventh example of the system, optionally including one or more or each of the first through sixth examples, the first molded port casing member further includes a first circular opening that extends from an exterior side of the first molded port casing member to the interior side of the first molded port casing member, forming a first tubular portion wherein fluid is transported to an exterior of the molded port assembly. In an eighth example of the system, optionally including one or more or each of the first through seventh examples, the plurality of projecting members of the second molded port casing member are in contact with the first tubular portion of the first molded port casing member.

The disclosure also provides support for a battery pack assembly, comprising: a plurality of cells arranged within a battery housing of the battery pack assembly, wherein the battery housing is configured for a port housing that encloses a pair of port assemblies, each port assembly, comprising: a port outlet coupled to a first port casing member that comprises a first base portion, a first elevated portion configured for a first fastener disposed on one side of the port outlet, and a second elevated portion configured for a second fastener disposed on another side of the port outlet, and a port inlet coupled to second port casing member that comprises a first tier and a second tier and is spaced apart from the first port casing member via a seal. In a first example of the system, the port inlet of each port assembly extends through the port housing on an interior side of the battery pack assembly. In a second example of the system, optionally including the first example the port outlet extends through the port housing on an exterior side of the battery pack assembly.

FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another.

Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Features described as axial may be approximately parallel with an axis referenced unless otherwise specified. Features described as counter-axial may be approximately perpendicular to the axis referenced unless otherwise specified. Features described as radial may be circumferentially around or extend in a radially outward from an axis, such as the axis referenced, or a component or feature described prior as being radial to a referenced axis, unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A port assembly, comprising:
a first port casing member that is coupleable with a second port casing member that is tiered via a pair of fasteners that extend from the second port casing member to the first port casing member to compress a seal spaced between the first port casing member and the second port casing member;
a port outlet positioned on a surface of the first port casing member; and
a port inlet positioned on a surface of the second port casing member.

2. The port assembly of claim 1, wherein the port outlet is removable and replaceable from outside a battery pack.

3. The port assembly of claim 1, wherein the first port casing member comprises a first base portion with a cross section that is rounded rectangular in shape and two elevated portions positioned on a top surface of the first base portion of the first port casing member, the two elevated portions being configured with through holes that position the pair of fasteners.

4. The port assembly of claim 3, wherein the two elevated portions are spaced apart spaced apart on either side of a center of the first base portion of the first port casing member and offset from the center of the first base portion by a pre-determined distance such that one elevated portion of the first port casing member is positioned on one side of the port outlet and another elevated portion is positioned on another side of the port outlet.

5. The port assembly of claim 1, wherein the second port casing member includes a first tier and a second tier, the second tier comprising a second base portion with a cross section that is rounded rectangular in shape and two elevated portions with a cross section that is circular in shape and positioned on a top surface of the second base portion of the second port casing member.

6. The port assembly of claim 5, wherein the two elevated portions of the second tier are spaced apart on either side of a center of the second base portion of the second port casing member and offset from the center of the second base portion by a pre-determined distance such that one elevated portion of the second tier is positioned on one side of the port inlet and another elevated portion is positioned on another side of the port inlet.

7. The port assembly of claim 5, wherein a cross section of the first tier is a rounded rectangular shape, the cross section of the first tier is larger in size compared to the cross section of the second base portion of the second tier, and a center of the first tier is aligned with the center of the second base portion of the second tier.

8. The port assembly of claim 5, wherein the seal surrounds an inner perimeter of the first port casing member and an inner perimeter of the first tier of the second port casing member.

9. A molded port assembly, comprising:
a port outlet coupled to a first molded port casing member, the first molded port casing member being arranged with a first base portion, a first elevated portion configured with a first through hole that is positioned on one side of the port outlet and a second elevated portion configured with a second through hole that is positioned on another side of the port outlet;
a port inlet that is coaxial with the port outlet and coupled to a second molded port casing member, the second molded port casing member comprising a first tier and a second tier, the second tier comprising a second base portion, a third elevated portion positioned on one side of the port inlet, and a fourth elevated portion positioned on another side of the port inlet;
wherein the first through hole positions a first fastener and the second through hole positions a second fastener that compress a seal wherein one side of the seal is positioned on an inner perimeter of the first molded port casing member and another side of the seal is positioned on an inner perimeter of the second molded port casing member.

10. The molded port assembly of claim 9, wherein the second base portion, the third elevated portion, and the fourth elevated portion of the second tier extend into an interior side of the second molded port casing member where triangular supports disposed on both of the third elevated portion and the fourth elevated portion connect the second base portion with the third elevated portion and the fourth elevated portion.

11. The molded port assembly of claim 10, wherein the second tier includes a second circular opening that extends from an exterior side of the second molded port casing member to the interior side of the second molded port casing member, forming a second tubular portion wherein fluid is transported to an interior of the molded port assembly.

12. The molded port assembly of claim 11, wherein rectangular supports are disposed around a perimeter of the second tubular portion to connect the second tubular portion to the second tier and a plurality of projecting members extends from an outer perimeter of an end of the second tubular portion.

13. The molded port assembly of claim 12, wherein a shape of each projecting member is a rectangular prism with a portion of one side of one end of the respective projecting member having a rounded wedge shape.

14. The molded port assembly of claim 10, wherein the first fastener and the second fastener are not coaxial and a first positioning member and a second positioning member are cylindrical in shape and configured to be positioned inside the third elevated portion and the fourth elevated portion of the second molded port casing member and receive the first fastener and the second fastener, respectively.

15. The molded port assembly of claim 14, wherein the first molded port casing member includes an inner wall that forms a cross section that is rounded rectangular in shape, the cross section of the inner wall being smaller than a cross section of the first base portion of the first molded port casing member.

16. The molded port assembly of claim 15, wherein the first molded port casing member further includes a first circular opening that extends from an exterior side of the first molded port casing member to the interior side of the first molded port casing member, forming a first tubular portion wherein fluid is transported to an exterior of the molded port assembly.

17. The molded port assembly of claim 16, wherein the plurality of projecting members of the second molded port casing member are in contact with the first tubular portion of the first molded port casing member.

18. A battery pack assembly, comprising:
a plurality of cells arranged within a battery housing of the battery pack assembly;
wherein the battery housing is configured for a port housing that encloses a pair of port assemblies, each port assembly, comprising:
a port outlet coupled to a first port casing member that comprises a first base portion, a first elevated portion configured for a first fastener disposed on one side of the port outlet, and a second elevated portion configured for a second fastener disposed on another side of the port outlet; and
a port inlet coupled to second port casing member that comprises a first tier and a second tier and is spaced apart from the first port casing member via a seal.

19. The battery pack assembly of claim 18, wherein the port inlet of each port assembly extends through the port housing on an interior side of the battery pack assembly.

20. The battery pack assembly of claim 18, the port outlet extends through the port housing on an exterior side of the battery pack assembly.
